(19) United States
(12) Patent Application Publication
(10) Pub. No.: US 2010/0206186 A1
(43) Pub. Date: Aug. 19, 2010

(54) INTRODUCED IN APPARATUS FOR BRIQUETTING DRY CRUSHED CANE AND OTHER BAGASSES

(76) Inventor: Carlos FRAZA, Sao Paulo (BR)

Correspondence Address: OSTROLENK FABER GERB & SOFFEN, 1180 AVENUE OF THE AMERICAS, NEW YORK, NY, 100368403, US

(21) Appl. No.: 12/370,919

(22) Filed: Feb. 13, 2009

(51) Int. Cl. B30B 11/00

(52) U.S. Cl. 100/94

(57) ABSTRACT

IMPROVEMENT INTRODUCED IN APPARATUS FOR BRIQUETTING DRY CRUSHED CANE AND OTHER BAGASSES constituted by reception, on upper and lower deflector plates of feed hopper, of dry crushed cane and other bagasses, broken up by rotating shaft bearing long and short rods for capture by collector blades of distributor screw driven by geared electric motor, the same being forced into guide tubes having endless screws of progressively smaller pitch driven by geared electric motor for the purpose of precompaction of said dry crushed cane and other bagasses in precompaction chamber, being compressed by compactor pistons within cylindrical tube having a slightly conical base forming briquette, said pistons being driven through the action of crankshaft supported by block driven by large electric motor, the finished briquettes passing through guide arms being ruptured by curved rods, the development whereof permitting the obtainment of an apparatus having simple operation and compact size permitting conversion of dry crushed cane and other bagasses into briquettes of differentiated sizes, called “Bripell”, suitable for use in industrial furnaces and boilers and in residential fireplaces.

### BACKGROUND OF THE INVENTION

The present patent specification relates to improvement introduced in apparatus for briquetting dry crushed cane and other bagasses, the development whereof has led to the obtainment of apparatus of simple operation and compact size permitting conversion of dry crushed cane and other bagasses into briquettes of size suitable for use in industrial furnaces and boilers and in residential fireplaces.

Since the origins of mankind, with the discovery of fire as a source of energy and heat, growth in consumption of diverse sources of energy, whether for heat generation or to produce electrical energy, has increased and on occasion has even entailed great environmental danger. This is a result of increased economic capacity which, as a consequence, generates demand for personal comfort.

The foregoing has occurred since the most uncivilized stage of development of modern civilization wherein all kinds of assault on Nature have been employed, with destruction of forests for obtainment of vegetable charcoal, or the use of coal for utilization in furnaces for the obtainment of heat energy.

Resulting from this manner of aggressive use rapid loss of areas of virgin forest occurred by virtue of the fact that capacity for the replacement of trees is much lower than the removal thereof. Included among large consumers are iron and steel plants and foundries requiring substantial quantities of coke, being unable to allow the furnaces to cool. Creation of forests cultivated for firewood production has increased, however still in a very insubstantial manner by virtue of the fact that employment of extensive cultivatable areas solely for this type of material meets strong resistance from environmentalists.

The problem is even more serious in respect of coal mines by virtue of the fact that replacement will only occur after thousands of years and world reserves are falling rapidly. Another problem with the use of this energy source lies in the fact of it having a strong environmental impact.

Furthermore the comfort generated by new modern electrical and electronic devices has compelled investment in augmenting the production and efficiency of electricity-generating installations.

From thermal power stations to modern hydroelectric power stations, including seeking more efficient solutions through nuclear energy, much research has been realized and a great deal of capital has been invested to satisfy the aforementioned demand. New sources of energy include photovoltaic cells, thermosolar, the use of hydrogen and of biomass.

Usage of biomass employs waste from plants subsequent to harvesting, or those cultivated specifically for this purpose, having the objective of augmenting the potential of this energy matrix and preventing, during the process of decomposition thereof, generation of methane gas considered to be an element prejudicial to the ozone layer, the combustion whereof generates carbon dioxide which, in spite of also being a pollutant, causes less damage to the aforementioned ozone layer.

The widespread availability of petroleum and its derivatives has hindered the emergence of studies for obtaining new energy matrices for utilization in automobile vehicles. The 1973 energy crisis imposed such a search resulting in studies for the obtainment of alternative fuels.

Studies regarding utilization of methyl alcohol or methanol and ethyl alcohol or ethanol as an energy matrix for automobile vehicles already exist in several countries, methanol and ethanol being derived from various types of plant. Brazil became one of the great examples of success in the utilization of ethyl alcohol or ethanol from sugarcane as a source for replacing energy of fossil origin by energy from renewable sources as an energy matrix for use in automobile vehicles.

It is the case that extraction of juice for production of fuel alcohol and sugar represents solely one part of the energy matrix of sugarcane, the bagasse and tops having been wasted until now as an energy source. Merely for information purposes, juice represents solely one third of the energy potential of sugarcane.

Some sugar and alcohol mills, as a manner of augmenting exploitation of the energy matrix, have combusted cane bagasse directly in furnaces for heat and electrical energy generation, both for their own consumption and to sell the surplus in the electrical energy market. The major problem with direct combustion of cane bagasse lies in it still containing a certain level of humidity and, when cast into the furnace, consuming part of the heat from combustion solely in order to dry the new charge of bagasse, only then generating sufficient heat to appropriately drive the steam turbine, as a result thereof in addition to a drop in efficiency there occurring a substantial loss of time.

It must be noted that combustion in the aforementioned manner has led to poor and inconsistent performance. It was perceived that to improve combustion efficiency it was necessary to suitably dry the sugarcane bagasse.

The most common solution utilized to date is to dry bagasse in rotary driers constituted by large metal cylindrical tubular tanks encircled by rings and supported on a bed rotating around an imaginary longitudinal axis through the action of an electric motor and gearing. Hot air is injected axially into the interior of such tank, crossing therethrough, cooler humid air exiting at the other side whilst fixed beater plates carry bagasse to the upper part of the tank “casting it down” through the aforementioned current of hot air.

For diverse reasons it has been found that this manner of drying is not as efficient as desired by virtue of the fact that the increased consumption of electrical energy to rotate such tank containing cane bagasse does not compensate for the work of drying.

Furthermore the direct introduction of hot air in a straight trajectory crossing the tank, in addition to not providing great drying efficiency by virtue of the hot air not filling the entire tank, may lead to combustion of the bagasse and consequent incineration thereof and total loss of the product being dried.

The applicant has developed a very much more efficient cane bagasse drier denominated IMPROVEMENT INTRODUCED INTO THE PROCESS OF DRYING CRUSHED CANE OR OTHER BAGASSES FOR SUBSEQUENT BRIQUETTING OR OTHER PROCESSES permitting a reduction in the moisture present in sugarcane and other bagasses on sugarcane crushing for obtainment of the liquid for alcohol and sugar production.

Dry cane and other bagasses, although containing a degree of moisture, may be used for the production of pellets and briquettes, a solution permitting an increase in their calorific value.

The problem with the aforesaid solution lies in the processes utilized to date wherein the machinery is voluminous and expensive, designed for the production of pellets for use in small burners, and briquettes, generally having diameters between 55 and 65 mm and lengths between 95 and 105 cm, for consumption in large furnaces.

It must be noted that manufacture of specific machinery for the production of pellets and briquettes is not justified, it resulting in appreciable costs solely to satisfy different constituencies.

### SUMMARY OF THE INVENTION

In the patent applied for herein, the improvement introduced into apparatus for briquetting bagasse from dry crushed sugarcane and other bagasses is constituted by a unit which in addition to being substantially compact is of easy operation and low manufacturing cost, by virtue of utilizing components which may be turned to advantage from diesel automotive vehicles having pistons in line such as the engine block, crankshaft and pistons, for the manufacture thereof and which produces a briquette having a diameter of approximately 38 mm, herein called “Bripell”, from compaction of dry crushed cane and other bagasses, which solution in addition to turning to advantage such waste from the production of alcohol and of sugar permits the final product (Bripells) to be utilized as briquettes or as pellets in combustion in furnaces/boilers, in fireplaces, or in furnaces for (thermoelectric) electricity generation.

In this manner an increase is achieved in the energy potential of waste customarily discarded and which has been, subsequently, turned to advantage for the generation of electrical energy, albeit in an inadequate manner.

Dry crushed cane and other bagasses are received by means of an inclined screw conveyer from the aforementioned drier and dropped into a buffer silo for storage which drops it in a continuous manner into a hopper feeding said briquetting machine, the functioning whereof in a pulsed manner results in the compacted bagasse having the form of discs or “coins”, that is to say the bar of Bripells is visually continuous presenting however relatively-long well-compacted sections followed by discs of mass which is somewhat less compact at the points between the compacted phases. Said less-compact points permit such Bripells to be ruptured thereat when, for example, it is desired to manually feed flames in a fireplace. The briquetting machine itself optionally possesses at the extremities of the guide arms at the output of the finished Bripells curved rods to force rupture of the Bripells into predetermined sizes.

Such briquetting machine feeds a silo feeding a rotary table for filling large bags or, withdrawing said silo and rotary table assembly, permitting the direct continuous filling of a tipper truck body.

The solution herein provided involves a five-cylinder in-line motor however nothing prevents the same having more or less cylinders. Furthermore a solution may be developed specifically for this function, dispensing with the utilization of parts or components of diesel engines as has been stated.

For better comprehension of the subject of the present patent reference is made to the annexed drawings wherein:

### BRIEF DESCRIPTION OF THE DRAWINGS

FIG. 1 shows in plan view the arrangement of the feed silo of said briquetting apparatus and the silo for reception of broken Bripells in the form of short cylinders for bagging on a rotary table or discharging into tipper truck bodies (not shown) subsequent to the drying unit;

FIG. 2 shows in side elevation the arrangement of the feed silo of said briquetting apparatus and the silo for reception of broken Bripells in the form of short cylinders for bagging on a rotary table or discharging into tipper truck bodies (not shown) subsequent to the drying unit;

FIG. 3 shows in plan view said briquetting apparatus, there being observed the feed hopper thereof having deflector plates uniformly dispersing dry crushed cane and other bagasses therewithin;

FIG. 4 shows in front elevation the aforementioned briquetting apparatus, there being observed the electric motor driving the crankshaft to drive the pistons which compact dry crushed sugarcane and other bagasses and the endless screw units responsible for precompaction of sugarcane and other bagasse, for subsequent sequential compaction;

FIG. 5 shows in left elevation the aforementioned briquetting apparatus, there being observed the electric motor, reducing pulleys and belts driving the crankshaft driving the pistons which compact dry crushed sugarcane and other bagasses, feed hopper and sprocket wheels, synchronized by chains, of shafts having disposed thereon rods for breaking up and for driving the bagasse within it, and units having endless screws responsible for precompaction of sugarcane and other bagasses, for subsequent sequential compaction;

FIG. 6 shows in right elevation the aforementioned briquetting apparatus, there being observed the small geared electric motor simultaneously driving the shaft of the distributor screw having blades collecting and forcing dry bagasse into the endless precompactor screws and one of the shafts having disposed thereon rods for breaking up and moving the bagasse;

FIG. 7 shows in rear elevation the aforementioned briquetting apparatus, there being observed the guide arms at the output of the finished Bripells, the function thereof being to assist in cooling and rupturing them in predetermined sizes;

FIG. 8 shows in upper front perspective view the aforementioned feed hopper, there being observed the deflector plates and shafts having disposed thereon rods for breaking up and driving the bagasse within it, and the distributor screw having blades collecting and impelling dry bagasse into the endless precompactor screws;

FIG. 9 shows in upper front perspective view the aforementioned distributor screw having blades collecting and impelling dry bagasse into the endless precompactor screws;

FIG. 10 shows in side elevation one of the endless precompactor screws, it being observed that such screw has a progressively-smaller pitch and having at its extremity pins disposed thereon preventing bagasse for compaction from remaining stationary within the precompactor chamber;

FIG. 11 shows in upper front perspective view the aforementioned endless precompactor screw, it being observed that said screw has a progressively smaller pitch;

FIG. 12 shows in partial cross-section the aforementioned endless precompactor screw mounted in the cradle thereof secured in the precompactor chamber;

FIG. 13 shows in longitudinal cross-sectional details of the arrangement of deflector plates and of shafts having disposed thereon rods for breaking up and driving bagasse and the distributor screw having collector blades located within the feed hopper, and one of the endless precompactor screws feeding precompaction chambers for cane and other bagasses, for final compaction by the compactor pistons, central-axially integral with the pistons of the diesel engine or others;

FIG. 14 shows in vertical cross-section details of the compactor tube, there being noted the slight conicity of the output extremity which compacts sugarcane;

FIG. 15 shows in cross-sectional view A-A′ details of one of the guide arms which in addition to its principal function, assists in cooling the Bripell;

FIG. 16 shows in upper front perspective view the aforementioned briquetting apparatus, there being observed the feed hopper thereof having deflector plates and geared electric motor rotating the shafts having rods for breaking up and driving bagasse, distributor screw having collector blades, geared electric motor driving the endless precompactor screws and the engine block driving the compactor pistons of the dry crushed sugarcane and other bagasses, and;

FIG. 17 shows in upper rear perspective view the aforementioned briquetting apparatus, there being observed the feed hopper thereof having deflector plates and guide arms for finished Bripells rupturable by small curved rods located at the extremities thereof.

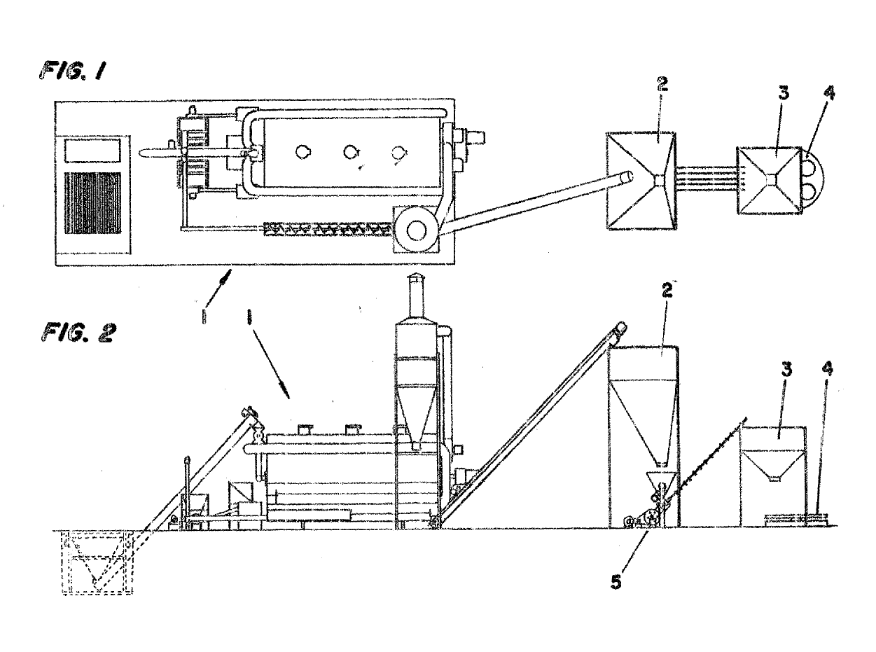

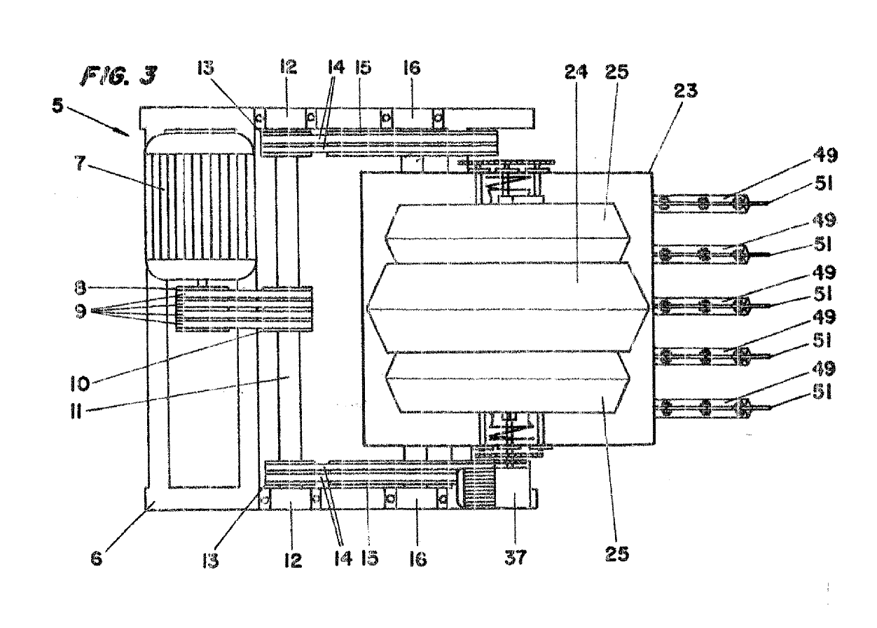

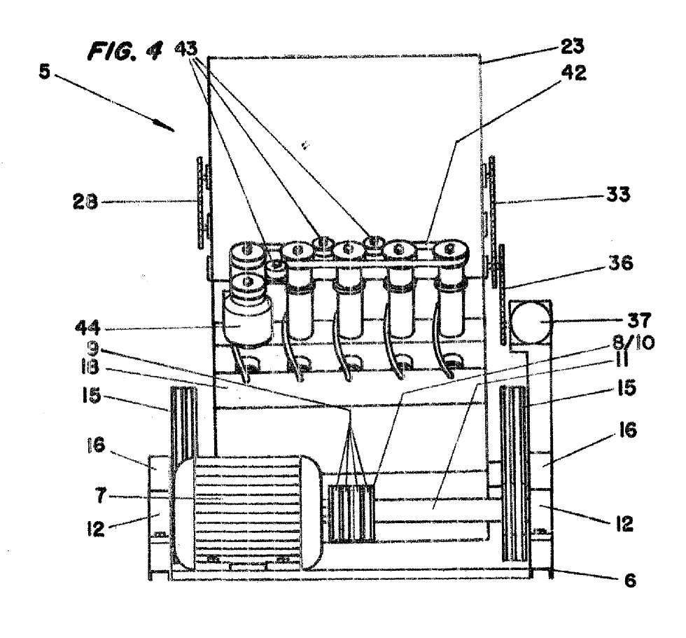

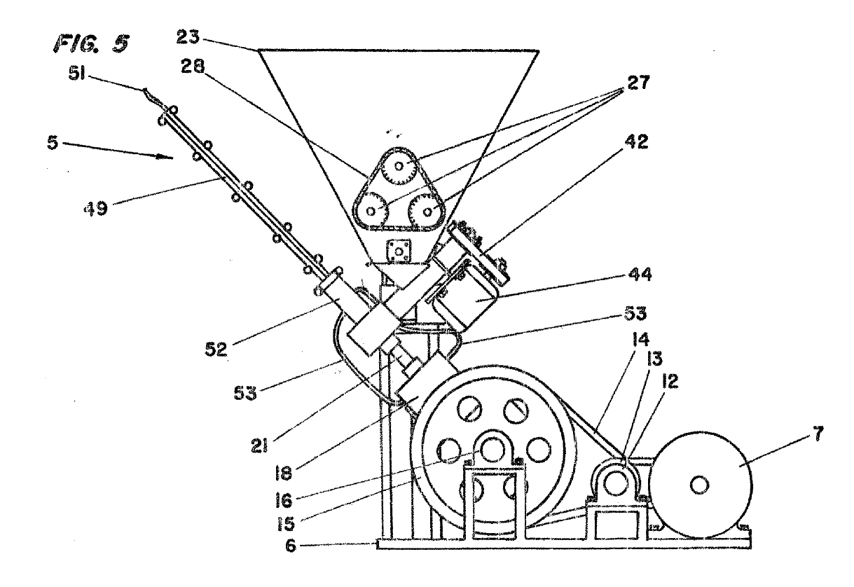

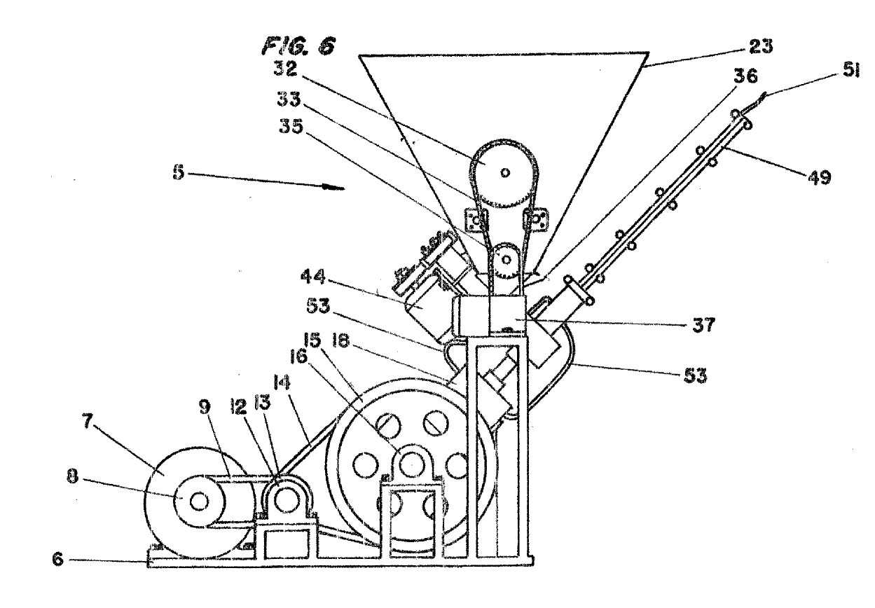

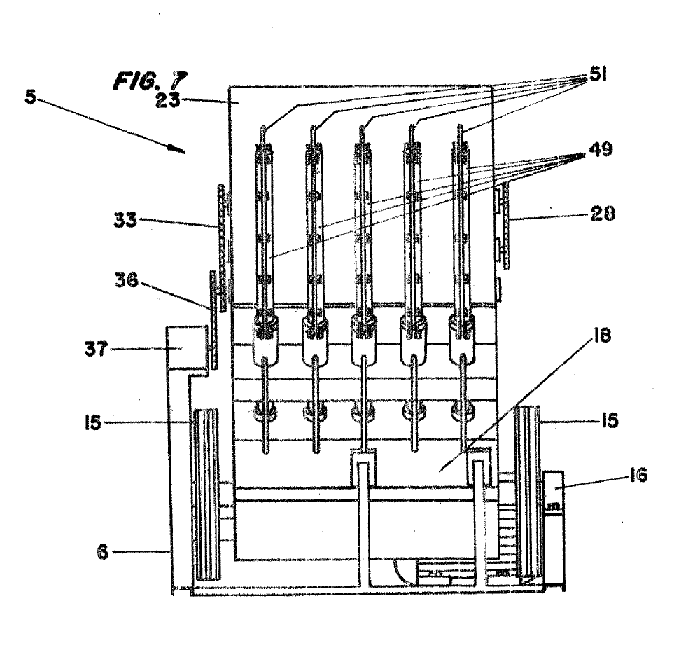

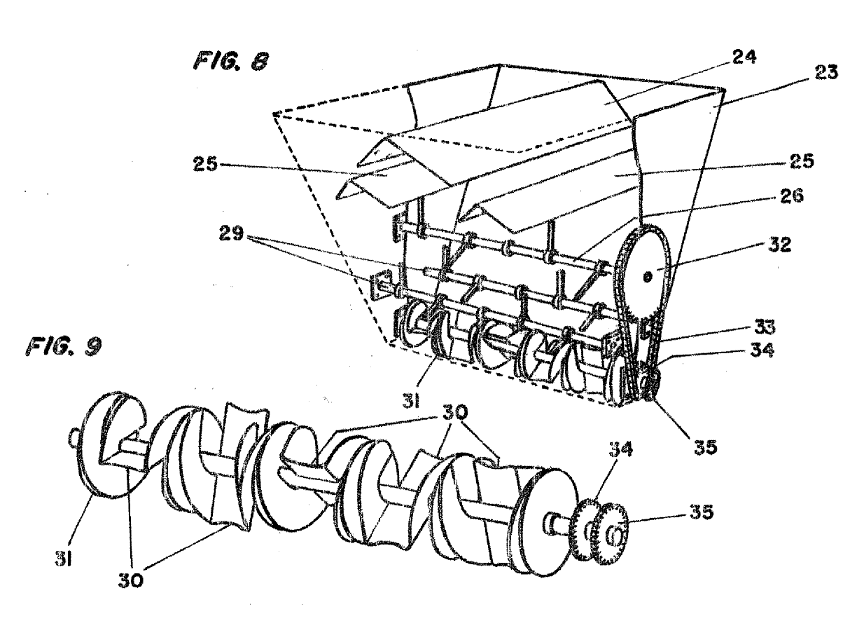

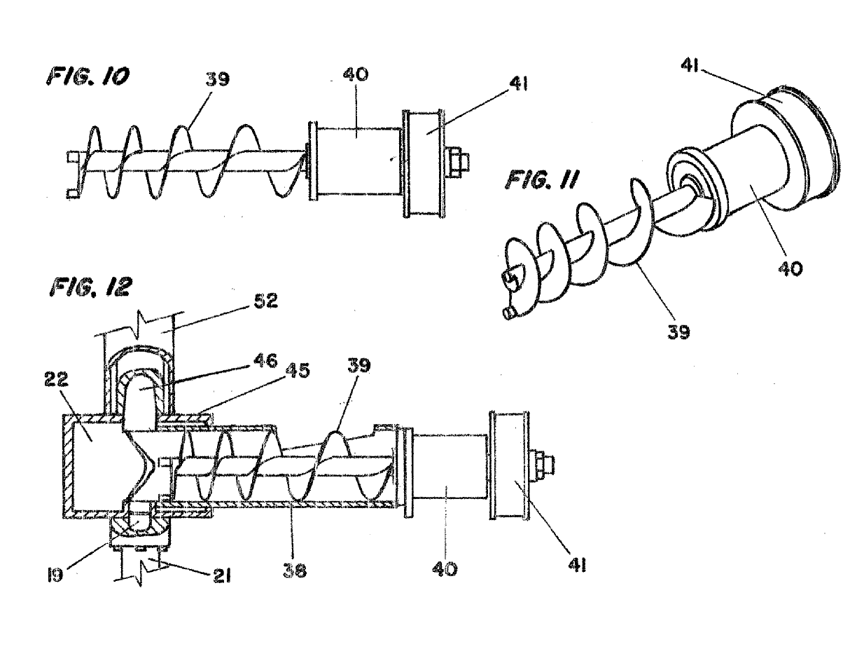

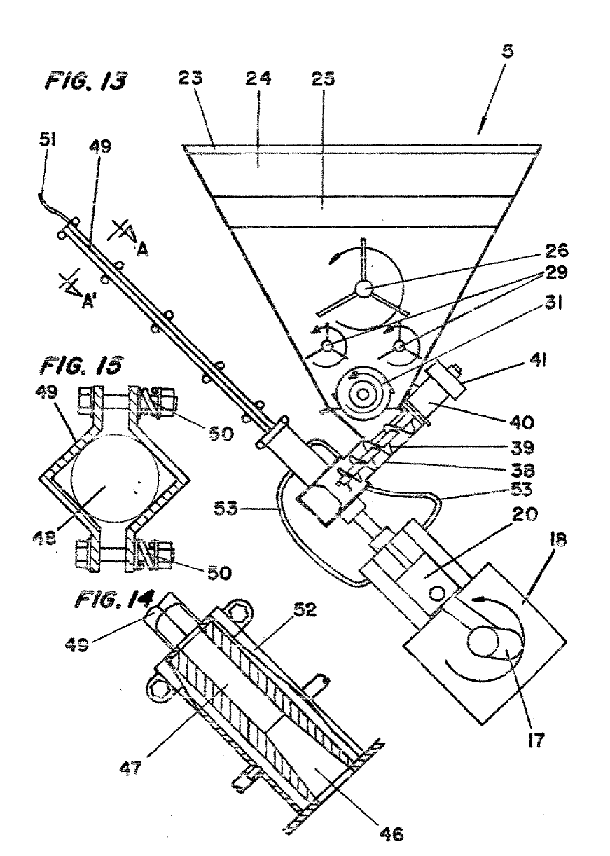

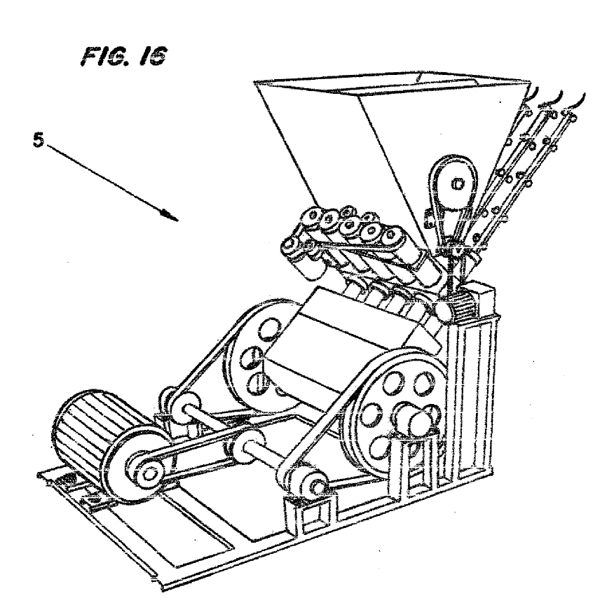

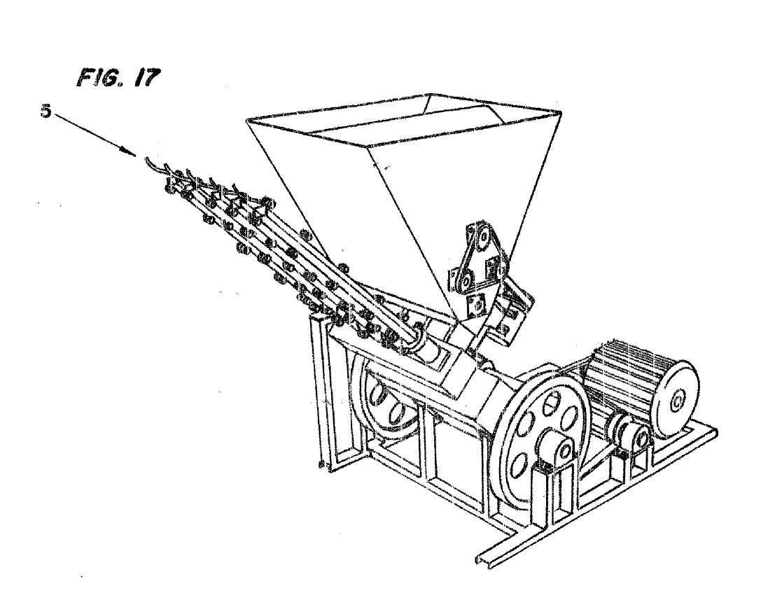

### DESCRIPTION OF PREFERRED EMBODIMENTS

The present patent specification relates to IMPROVEMENT INTRODUCED IN APPARATUS FOR BRIQUETTING DRY CRUSHED CANE AND OTHER BAGASSES, which is constituted by incorporation, subsequent to drying unit (1) and beneath buffer silo (2) and prior to the silo for packing finished Bripells (3), the latter occurring on rotary bagging table (4), of briquetting apparatus (5) constituted by a base of metal sections (6) having in the frontal part thereof a large electric motor (7) driving by pulley (8) and belts (9) a central pulley (10) on shaft (11), the latter supported by bearings (12), to simultaneously drive lateral pulleys (13) by belts (14) driving reducing pulleys (15) having bearings (16) supporting crankshaft (17) supported by block (18), positioned transversely at an angle of 45°, the cylinder head whereof having been removed and having compactor pistons (19) of diameter approximately 38 mm affixed central-axially on pistons (20) of said block (18), linked by guide tubes (21) to casing of precompaction chambers (22), said guide tubes (21) covering the apertures of the cylinders of pistons (20) of block (18); dry crushed sugarcane and other bagasses falling from said buffer silo (2) into feed hopper (23) onto upper (24) and lower (25) deflector plates responsible for uniform distribution within said hopper (23) and by virtue of such bagasse tending to remain structured and not “flow”, the same being broken up by rotating shaft having disposed thereon long rods (26) driving, in a synchronized manner by external sprocket wheels (27) and chain (28), lower rotary shafts bearing short rods (29) for the purpose of maintaining the same in broken-up state for capture by collector blades (30) of distributor screw (31) located at the bottom of said feed hopper (23); at the opposite extremity of said shaft (26) and integral thereto there being large external sprocket wheel (32) driven by chain (33) driven by external sprocket wheel (34) integral with distributor screw shaft (31) and integral thereon a further external sprocket wheel (35) driven by chain (36) by sprocket wheel (not visible) of geared electric motor (37); cane and other bagasses collected by blades (30) of distributor screw (31) being forced into a plurality of guide tubes (38) having endless screws of progressively smaller pitch (39) to increase precompaction of cane and other bagasses, each shaft of said endless screws (39) rotating in a bearing (40) secured in a suitable support (not visible) provided with pulley (41) driven by belt (42), duly tensioned by rollers (43), by geared electric motor (44), said tubes (38) being secured in tubular sleeves (45) secured in said precompaction chamber (22) such as to force the introduction of cane and other bagasses, endless screws (39) being provided at their extremity with pins forcing the movement of bagasse into precompaction chamber (22), such bagasse being compacted by compactor pistons (19) within cylindrical tube having a slightly conical frontal section (46) and cylindrical base (47), forming the Bripell (48) obliged to pass through guide arms (49) which also assist in cooling, the pressure whereof on said Bripell being regulatable by nuts and bolts and helicoidal pressure springs (50), said Bripells (48) being (optionally) ruptured by curved rods (51) suitably affixed at the extremities of guide arms (49); cylindrical tube (46) being surrounded by jacket (52) of refrigerant liquid for heat exchange with engine block (18) by means of pipework (53) and, should overheating occur, having a radiator (not shown).

1. IMPROVEMENT INTRODUCED IN APPARATUS FOR BRIQUETTING DRY CRUSHED CANE AND OTHER BAGASSES incorporated subsequent to drying unit beneath buffer silo and prior to silo for packing finished briquettes, the latter occurring on rotary bagging table, wherein said briquetting apparatus is constituted by a base of metal sections having in the frontal part thereof a large electric motor driving by pulley and belts a central pulley on shaft, the latter supported by bearings, to simultaneously drive lateral pulleys by belts driving reducing pulleys having bearings supporting crankshaft supported by block, positioned transversely at an angle of 45°, the cylinder head whereof having been removed and having compactor pistons of diameter approximately 38 mm affixed central-axially on pistons of said block, linked by guide tubes to casing of precompaction chambers, said guide tubes covering the apertures of the cylinders of pistons of block; dry crushed sugarcane and other bagasses falling from said buffer silo into feed hopper onto upper and lower deflector plates responsible for uniform distribution within said hopper and by virtue of such bagasse tending to remain structured and not “flow”, the same being broken up by rotating shaft having disposed thereon long rods driving, in a synchronized manner by external sprocket wheels and chain, lower rotary shafts bearing short rods for the purpose of maintaining the same in broken-up state for capture by collector blades of distributor screw located at the bottom of said feed hopper; at the opposite extremity of said shaft and integral thereto there being large external sprocket wheel driven by chain driven by external sprocket wheel integral with distributor screw shaft and integral thereon a further external sprocket wheel driven by chain by sprocket wheel (not visible) of geared electric motor; cane and other bagasses collected by blades of distributor screw being forced into a plurality of guide tubes having endless screws of progressively smaller pitch to increase precompaction of cane and other bagasses, each shaft of said endless screws rotating in a bearing secured in a suitable support (not visible) provided with pulley driven by belt, duly tensioned by rollers, by geared electric motor, said tubes being secured in tubular sleeves secured in said precompaction chamber such as to force the introduction of cane and other bagasses, endless screws being provided at their extremity with pins forcing the movement of bagasse into precompaction chamber, such bagasse being compacted by compactor pistons within cylindrical tube having a slightly conical frontal section and cylindrical base, forming the Bripell obliged to pass through guide arms which also assist in cooling, the pressure whereof on said briquette being regulatable by nuts and bolts and helicoidal pressure springs, said briquettes being (optionally) ruptured by curved rods suitably affixed at the extremities of guide arms; cylindrical tube being surrounded by jacket of refrigerant liquid for heat exchange with engine block by means of pipework and, should overheating occur, having a radiator (not shown).
